(19) United States
(12) Patent Application Publication
(10) Pub. No.: US 2015/0088764 A1
(43) Pub. Date: Mar. 26, 2015

(54) ONE-STOP COMPREHENSIVE PRODUCT WARRANTY COMPUTERIZED MANAGEMENT SYSTEM

(71) Applicant: Saeed Sassan, Brentwood, TN (US)

(72) Inventor: Saeed Sassan, Brentwood, TN (US)

(21) Appl. No.: 14/038,245

(22) Filed: Sep. 26, 2013

(51) Int. Cl. G06Q 30/00

(52) U.S. Cl. CPC G06Q 30/012
USPC 705/302

(57) ABSTRACT

A Warranty Management System (WMS) and method are disclosed including computer software modules that when executed allow a user to enter warranty information for multiple products and services into a database for management of the warranties. The management of the warranties include a single repository for all warranty information, offer of extended warranties, access to additional information related to products and/or their warranties from manufacturers and third party service providers, reminders and alerts about status and warranty expiration dates, warranty repair providers, warranty claim management, addition and editing of warranty information, information search, warranty certificate storage, and the like.

### TECHNICAL FIELD

This application relates generally to computerized service management. More specifically, this application relates to a computerized product and service warranty management system.

### BRIEF DESCRIPTION OF THE DRAWINGS

The drawings, when considered in connection with the following description, are presented for the purpose of facilitating an understanding of the subject matter sought to be protected.

FIG. 1 shows an embodiment of a network computing environment wherein the disclosure may be practiced;

FIG. 2 shows an embodiment of a computing device that may be used in the network computing environment of FIG. 1;

FIG. 3 shows an example webpage for product warranty registration that may be used in the computing environment of FIG. 1;

FIG. 4 shows an example webpage for account creation and other warranty registration activities related to the webpage of FIG. 3; and

FIG. 5 shows an example webpage for showing a list of customer warranties configured to allow adding new product warranties and editing existing warranty records.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references product and service warranties, it will be appreciated that the disclosure may be used with other types of contracts and agreements, such as real estate lease, service contracts like phone and security, and the like.

Briefly described, a Warranty Management System (WMS) and method are disclosed including computer software modules that when executed allow a user to enter warranty information for multiple products and services into a database for management of the warranties. The management of the warranties include a single repository for all warranty information, offer of extended warranties, access to additional information related to products and/or their warranties from manufacturers and third party service providers, reminders and alerts about status and warranty expiration dates, warranty repair providers, warranty claim management, addition and editing of warranty information, information search, warranty certificate storage, and the like.

Large markets like U.S., Europe, and Asia produce and sell millions of products to various private and business consumers. Additionally, many services are performed daily for customers on which the customers depend or expect a designated life. For most durable goods and services, the respective manufacturers and service providers usually provide a warranty certificate which guarantees some aspect of the product or the service, such as workmanship, material, and the like, for a designated period of time and subject to certain restrictions and limitations. Legally, a warranty certificate is an agreement between the buyer and the seller with particular provisions and conditions, like any other contract. For example, if a consumer buys a TeleVision (TV) set, the electronics of the TV set may be warranted for one year under normal use and care. Similarly, an auto mechanic may repair a car and provide a 6 month warranty for his workmanship. Economically, the cost of the warranty provided is embedded in the cost of the product or service. Thus, the warranty certificate has a cost associated with it for which the customer pays.

As the number of products and services which the consumers or businesses purchase increase, the number of corresponding warranties also increase, creating a management problem. People often miss the benefits of their warranties when a product or service fails prior to the expiration of its designated warranty for various reasons, such as not remembering whether they have a warranty or not, forgetting the warranty dates, misplacing their warranty certificates, forgetting the contact information for the product manufacturer or service provider, and the like. Thus, when a product or service warranty is not used, the customer suffers a financial loss by having to pay for any repairs of the failed product or re-performance of the service under warranty.

Hence, it is desirable to have a comprehensive warranty management system to fully utilize the benefits offered by product and service warranties.

### Illustrative Operating Environment

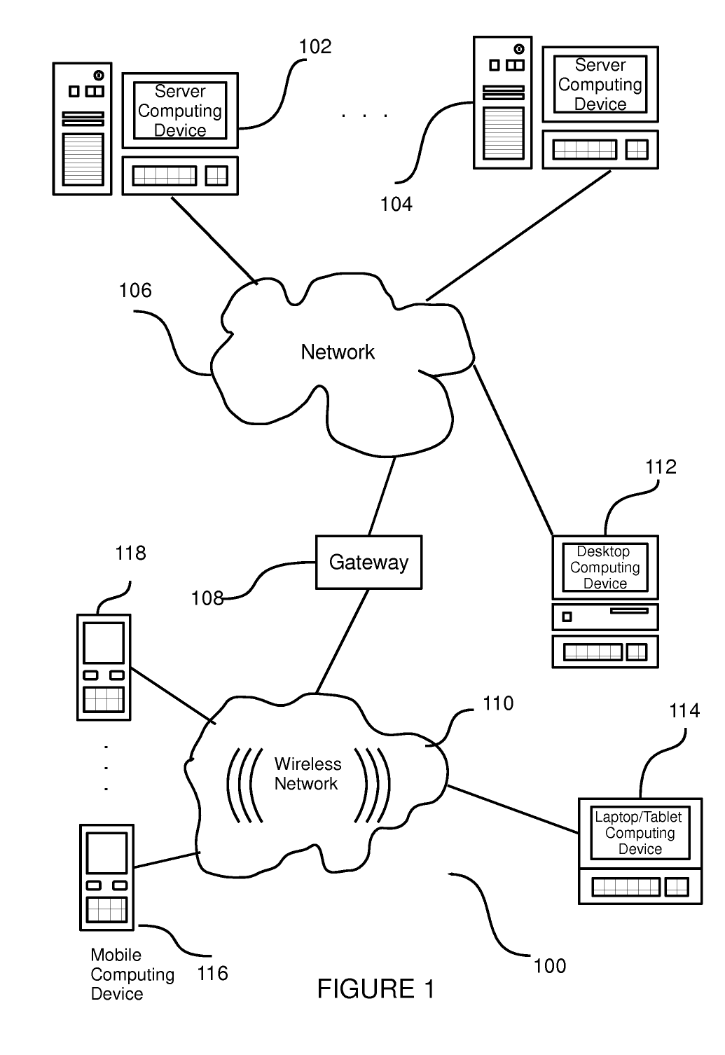

FIG. 1 shows components of an illustrative environment in which the disclosure may be practiced. Not all the shown components may be required to practice the disclosure, and variations in the arrangement and type of the components may be made without departing from the spirit or scope of the disclosure. System 100 may include Local Area Networks (LAN) and Wide Area Networks (WAN) shown collectively as Network 106, wireless network 110, gateway 108 configured to connect remote and/or different types of networks together, client computing devices 112-118, and server computing devices 102-104.

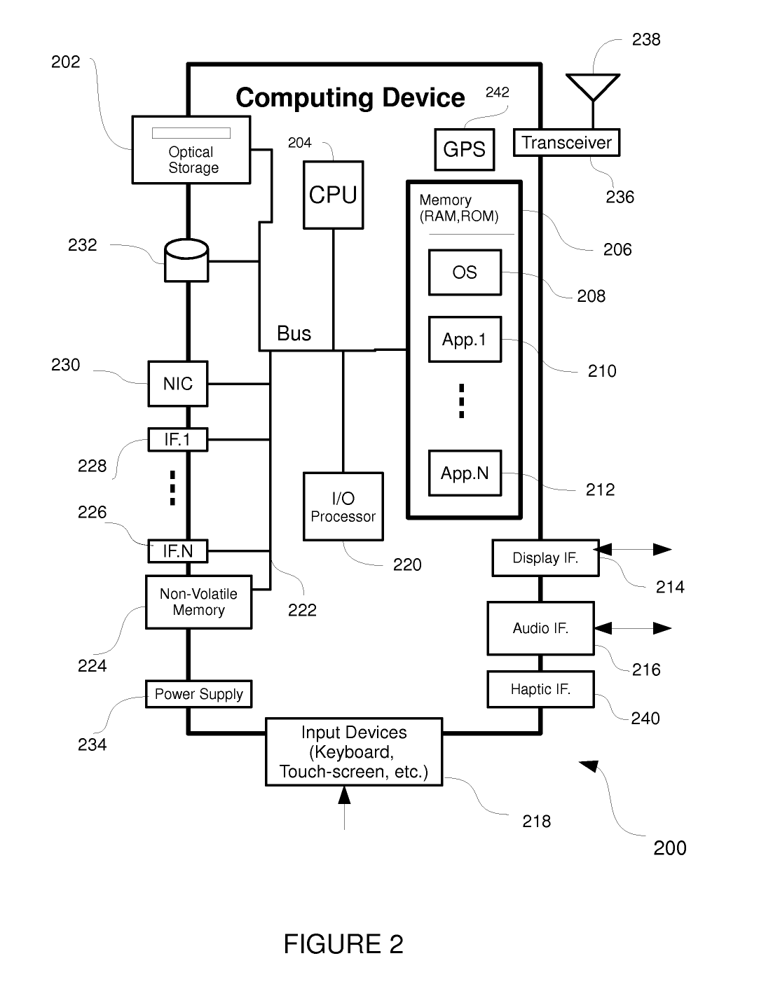

One embodiment of a computing device usable as one of client computing devices 112-118 is described in more detail below with respect to FIG. 2. Briefly, however, client computing devices 112-118 may include virtually any device capable of receiving and sending a message over a network, such as wireless network 110, or the like. Such devices include portable devices such as, cellular telephones, smart phones, display pagers, radio frequency (RF) devices, music players, digital cameras, infrared (IR) devices, Personal Digital Assistants (PDAs), handheld computers, laptop computers, wearable computers, tablet computers, integrated devices combining one or more of the preceding devices, or the like. Client device 112 may include virtually any computing device that typically connects using a wired communications medium such as personal computers, multiprocessor systems, microprocessor-based or programmable consumer electronics, network PCs, or the like. In one embodiment, one or more of client devices 112-118 may also be configured to operate over a wired and/or a wireless network.

Client devices 112-118 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphic may be displayed.

A web-enabled client device may include a browser application that is configured to receive and to send web pages, web-based messages, or the like. The browser application may be configured to receive and display graphic, text, multimedia, or the like, employing virtually any web based language, including a wireless application protocol messages (WAP), or the like. In one embodiment, the browser application may be enabled to employ one or more of Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client computing devices 12-118 also may include at least one other client application that is configured to receive content from another computing device, including, without limit, server computing devices 102-104. The client application may include a capability to provide and receive textual content, multimedia information, or the like. The client application may further provide information that identifies itself, including a type, capability, name, or the like. In one embodiment, client devices 112-118 may uniquely identify themselves through any of a variety of mechanisms, including a phone number, Mobile Identification Number (MIN), an electronic serial number (ESN), mobile device identifier, network address, such as IP (Internet Protocol) address, Media Access Control (MAC) layer identifier, or other identifier. The identifier may be provided in a message, or the like, sent to another computing device.

Client computing devices 112-118 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, to another computing device. However, the present disclosure is not limited to these message protocols, and virtually any other message protocol may be employed.

Client devices 112-118 may further be configured to include a client application that enables the user to log into a user account that may be managed by another computing device. Such user account, for example, may be configured to enable the user to receive emails, send/receive IM messages, SMS messages, access selected web pages, download scripts, applications, or a variety of other content, or perform a variety of other actions over a network. However, managing of messages or otherwise accessing and/or downloading content, may also be performed without logging into the user account. Thus, a user of client devices 112-118 may employ any of a variety of client applications to access content, read web pages, receive/send messages, or the like. In one embodiment, for example, the user may employ a browser or other client application to access a web page hosted by a Web server implemented as server computing device 102. In one embodiment, messages received by client computing devices 112-118 may be saved in non-volatile memory, such as flash and/or PCM, across communication sessions and/or between power cycles of client computing devices 112-118.

Wireless network 110 may be configured to couple client devices 114-118 to network 106. Wireless network 110 may include any of a variety of wireless sub-networks that may further overlay stand-alone ad-hoc networks, and the like, to provide an infrastructure-oriented connection for client devices 114-118. Such sub-networks may include mesh networks, Wireless LAN (WLAN) networks, cellular networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as client devices 114-118 with various degrees of mobility. For example, wireless network 110 may enable a radio connection through a radio network access such as Global System for Mobil communication (GSM), General Packet Radio Services (GPRS), Enhanced Data GSM Environment (EDGE), WEDGE, Bluetooth, High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between client devices 102-104 and another computing device, network, and the like.

Network 106 is configured to couple one or more servers depicted in FIG. 1 as server computing devices 102-104 and their respective components with other computing devices, such as client device 112, and through wireless network 110 to client devices 114-118. Network 106 is enabled to employ any form of computer readable media for communicating information from one electronic device to another. Also, network 106 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another.

In various embodiments, the arrangement of system 100 includes components that may be used in and constitute various networked architectures. Such architectures may include peer-to-peer, client-server, two-tier, three-tier, or other multi-tier (n-tier) architectures, MVC (Model-View-Controller), and MVP (Model-View-Presenter) architectures among others. Each of these are briefly described below.

Peer to peer architecture entails use of protocols, such as P2PP (Peer To Peer Protocol), for collaborative, often symmetrical, and independent communication and data transfer between peer client computers without the use of a central server or related protocols.

Client-server architectures includes one or more servers and a number of clients which connect and communicate with the servers via certain predetermined protocols. For example, a client computer connecting to a web server via a browser and related protocols, such as HTTP, may be an example of a client-server architecture. The client-server architecture may also be viewed as a 2-tier architecture.

Two-tier, three-tier, and generally, n-tier architectures are those which separate and isolate distinct functions from each other by the use of well-defined hardware and/or software boundaries. An example of the two-tier architecture is the client-server architecture as already mentioned. In a 2-tier architecture, the presentation layer (or tier), which provides user interface, is separated from the data layer (or tier), which provides data contents. Business logic, which processes the data may be distributed between the two tiers.

A three-tier architecture, goes one step farther than the 2-tier architecture, in that it also provides a logic tier between the presentation tier and data tier to handle application data processing and logic. Business applications often fall in and are implemented in this layer.

MVC (Model-View-Controller) is a conceptually many-to-many architecture where the model, the view, and the controller entities may communicate directly with each other. This is in contrast with the 3-tier architecture in which only adjacent layers may communicate directly.

MVP (Model-View-Presenter) is a modification of the MVC model, in which the presenter entity is analogous to the middle layer of the 3-tier architecture and includes the applications and logic.

Communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 106 may include any communication method by which information may travel between computing devices. Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

Illustrative Computing Device Configuration

FIG. 2 shows an illustrative computing device 200 that may represent any one of the server and/or client computing devices shown in FIG. 1. A computing device represented by computing device 200 may include less or more than all the components shown in FIG. 2 depending on the functionality needed. For example, a mobile computing device may include the transceiver 236 and antenna 238, while a server computing device 102 of FIG. 1 may not include these components. Those skilled in the art will appreciate that the scope of integration of components of computing device 200 may be different from what is shown. As such, some of the components of computing device 200 shown in FIG. 2 may be integrated together as one unit. For example, NIC 230 and transceiver 236 may be implemented as an integrated unit. Additionally, different functions of a single component may be separated and implemented across several components instead. For example, different functions of I/O processor 220 may be separated into two or more processing units.

With continued reference to FIG. 2, computing device 200 includes optical storage 202, Central Processing Unit (CPU) 204, memory module 206, display interface 214, audio interface 216, input devices 218, Input/Output (I/O) processor 220, bus 222, non-volatile memory 224, various other interfaces 226-228, Network Interface Card (NIC) 320, hard disk 232, power supply 234, transceiver 236, antenna 238, haptic interface 240, and Global Positioning System (GPS) unit 242. Memory module 206 may include software such as Operating System (OS) 208, and a variety of software application programs and/or software modules/components 210-212. Such software modules and components may be stand-alone application software or be components, such as DLL (Dynamic Link Library) of a bigger application software. Computing device 200 may also include other components not shown in FIG. 2. For example, computing device 200 may further include an illuminator (for example, a light), graphic interface, and portable storage media such as USB drives. Computing device 200 may also include other processing units, such as a math co-processor, graphics processor/accelerator, and a Digital Signal Processor (DSP).

Optical storage device 202 may include optical drives for using optical media, such as CD (Compact Disc), DVD (Digital Video Disc), and the like. Optical storage devices 202 may provide inexpensive ways for storing information for archival and/or distribution purposes.

Central Processing Unit (CPU) 204 may be the main processor for software program execution in computing device 200. CPU 204 may represent one or more processing units that obtain software instructions from memory module 206 and execute such instructions to carry out computations and/or transfer data between various sources and destinations of data, such as hard disk 232, I/O processor 220, display interface 214, input devices 218, non-volatile memory 224, and the like.

Memory module 206 may include RAM (Random Access Memory), ROM (Read Only Memory), and other storage means, mapped to one addressable memory space. Memory module 206 illustrates one of many types of computer storage media for storage of information such as computer readable instructions, data structures, program modules or other data. Memory module 206 may store a basic input/output system (BIOS) for controlling low-level operation of computing device 200. Memory module 206 may also store OS 208 for controlling the general operation of computing device 200. It will be appreciated that OS 208 may include a general-purpose operating system such as a version of UNIX, or LINUX™, or a specialized client-side and/or mobile communication operating system such as Windows Mobile™, Android®, or the Symbian® operating system. OS 208 may, in turn, include or interface with a Java virtual machine (JVM) module that enables control of hardware components and/or operating system operations via Java application programs.

Memory module 206 may further include one or more distinct areas (by address space and/or other means), which can be utilized by computing device 200 to store, among other things, applications and/or other data. For example, one area of memory module 206 may be set aside and employed to store information that describes various capabilities of computing device 200, a device identifier, and the like. Such identification information may then be provided to another device based on any of a variety of events, including being sent as part of a header during a communication, sent upon request, or the like. One common software application is a browser program that is generally used to send/receive information to/from a web server. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may also be employed. In one embodiment, using the browser application, a user may view an article or other content on a web page with one or more highlighted portions as target objects.

Display interface 214 may be coupled with a display unit (not shown), such as liquid crystal display (LCD), gas plasma, light emitting diode (LED), or any other type of display unit that may be used with computing device 200. Display units coupled with display interface 214 may also include a touch sensitive screen arranged to receive input from an object such as a stylus or a digit from a human hand. Display interface 214 may further include interface for other visual status indicators, such Light Emitting Diodes (LED), light arrays, and the like. Display interface 214 may include both hardware and software components. For example, display interface 214 may include a graphic accelerator for rendering graphic-intensive outputs on the display unit. In one embodiment, display interface 214 may include software and/or firmware components that work in conjunction with CPU 204 to render graphic output on the display unit.

Audio interface 216 is arranged to produce and receive audio signals such as the sound of a human voice. For example, audio interface 216 may be coupled to a speaker and microphone (not shown) to enable communication with a human operator, such as spoken commands, and/or generate an audio acknowledgement for some action.

Input devices 218 may include a variety of device types arranged to receive input from a user, such as a keyboard, a keypad, a mouse, a touchpad, a touch-screen (described with respect to display interface 214), a multi-touch screen, a microphone for spoken command input (describe with respect to audio interface 216), and the like.

I/O processor 220 is generally employed to handle transactions and communications with peripheral devices such as mass storage, network, input devices, display, and the like, which couple computing device 200 with the external world. In small, low power computing devices, such as some mobile devices, functions of the I/O processor 220 may be integrated with CPU 204 to reduce hardware cost and complexity. In one embodiment, I/O processor 220 may the primary software interface with all other device and/or hardware interfaces, such as optical storage 202, hard disk 232, interfaces 226-228, display interface 214, audio interface 216, and input devices 218.

An electrical bus 222 internal to computing device 200 may be used to couple various other hardware components, such as CPU 204, memory module 206, I/O processor 220, and the like, to each other for transferring data, instructions, status, and other similar information.

Non-volatile memory 224 may include memory built into computing device 200, or portable storage medium, such as USB drives that may include PCM arrays, flash memory including NOR and NAND flash, pluggable hard drive, and the like. In one embodiment, portable storage medium may behave similarly to a disk drive. In another embodiment, portable storage medium may present an interface different than a disk drive, for example, a read-only interface used for loading/supplying data and/or software.

Various other interfaces 226-228 may include other electrical and/or optical interfaces for connecting to various hardware peripheral devices and networks, such as IEEE 1394 also known as FireWire, Universal Serial Bus (USB), Small Computer Serial Interface (SCSI), parallel printer interface, Universal Synchronous Asynchronous Receiver Transmitter (USART), Video Graphics Array (VGA), Super VGA (SVGA), and the like.

Network Interface Card (NIC) 230 may include circuitry for coupling computing device 200 to one or more networks, and is generally constructed for use with one or more communication protocols and technologies including, but not limited to, Global System for Mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols.

Hard disk 232 is generally used as a mass storage device for computing device 200. In one embodiment, hard disk 232 may be a Ferro-magnetic stack of one or more disks forming a disk drive embedded in or coupled to computing device 200. In another embodiment, hard drive 232 may be implemented as a solid-state device configured to behave as a disk drive, such as a flash-based hard drive. In yet another embodiment, hard drive 232 may be a remote storage accessible over network interface 230 or another interface 226, but acting as a local hard drive. Those skilled in the art will appreciate that other technologies and configurations may be used to present a hard drive interface and functionality to computing device 200 without departing from the spirit of the present disclosure.

Power supply 234 provides power to computing device 200. A rechargeable or non-rechargeable battery may be used to provide power. The power may also be provided by an external power source, such as an AC adapter or a powered docking cradle that supplements and/or recharges a battery.

Transceiver 236 generally represents transmitter/receiver circuits for wired and/or wireless transmission and receipt of electronic data. Transceiver 236 may be a stand-alone module or be integrated with other modules, such as NIC 230. Transceiver 236 may be coupled with one or more antennas for wireless transmission of information.

Antenna 238 is generally used for wireless transmission of information, for example, in conjunction with transceiver 236, NIC 230, and/or GPS 242. Antenna 238 may represent one or more different antennas that may be coupled with different devices and tuned to different carrier frequencies configured to communicate using corresponding protocols and/or networks. Antenna 238 may be of various types, such as omni-directional, dipole, slot, helical, and the like.

Haptic interface 240 is configured to provide tactile feedback to a user of computing device 200. For example, the haptic interface may be employed to vibrate computing device 200, or an input device coupled to computing device 200, such as a game controller, in a particular way when an event occurs, such as hitting an object with a car in a video game.

Global Positioning System (GPS) unit 242 can determine the physical coordinates of computing device 200 on the surface of the Earth, which typically outputs a location as latitude and longitude values. GPS unit 242 can also employ other geo-positioning mechanisms, including, but not limited to, triangulation, assisted GPS (AGPS), E-OTD, CI, SAI, ETA, BSS or the like, to further determine the physical location of computing device 200 on the surface of the Earth. It is understood that under different conditions, GPS unit 242 can determine a physical location within millimeters for computing device 200. In other cases, the determined physical location may be less precise, such as within a meter or significantly greater distances. In one embodiment, however, a mobile device represented by computing device 200 may, through other components, provide other information that may be employed to determine a physical location of the device, including for example, a MAC address.

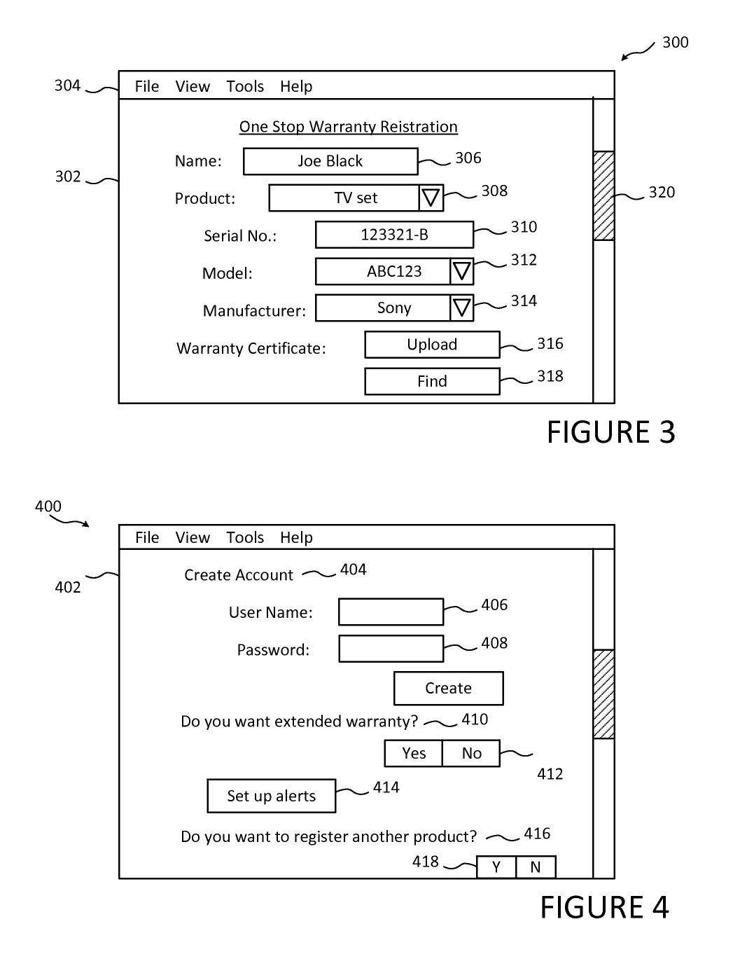

FIG. 3 shows an example webpage for product warranty registration that may be used in the computing environment of FIG. 1. In various embodiment webpage 300 includes content window 302, menu bar 304, scroll bar 320, and a number of fields for user inputs. The user input fields may include Name 306, Product identifier 308, product Serial Number 310, product Model Number 312, product Manufacturer 314, warranty certificate Upload button 316, and warranty certificate Find button 318.

In various embodiments, the Warranty Management System (WMS) may be implemented and displayed by a hardware and/or software system using one or more software components executing on the illustrative computing device of FIG. 2. The WMS may be coupled with a local or remote database to store warranty information from multiple users or customers, including product and service end-users who are warranty owners, and also manufacturers and service providers who are warranty providers. One or more functions may be performed by each software module. For example one or more separate software components may be used for each of the functions to manage graphics of the WMS, present a user interface, display tables or other data items, communicate with a database where warranty data records are stored, search for data records, filter various data items based on various parameters like time and type of warranty, monitor user preferences, generate alerts and warnings, provide data editing functions, and any other function needed to carry out and implement the functions of the WMS described herein. Those skilled in the art will appreciate that one function may implemented using multiple software modules or several functions may be implemented using one software module. With further reference to FIG. 2, these software modules are generally loaded into the memory module 206 of the computing device.

Those skilled in the art will appreciate that WMS may be implemented using other software constructs and techniques without departing from the spirit of the present disclosure. For example, instead of a webpage, the WMS may be provided in the form of a dedicated or standalone installable application on the user's computing device, such as a PC or a smartphone. Alternatively, the WMS may be presented as a client-server application with some parts of the functions, such as database operations, implemented as software modules on a server and other parts, such as the user interface and input, implemented as software modules on a client application running on the user's computing device.

In various embodiments, after creating an account with the WMS operator or owner, the user may start entering information about warranties he has for the various products and services he has purchased. Typically, the warranty information may include a product identifier such as a product name, the purchase date of the product, sale information such as price and store information, the product serial number and model number, and the product manufacturer. The user may also upload a copy of the warranty certificate, for example as a PDF formatted document or an image, using the interface provided.

In various embodiments, some of the warranty information may be entered by the user, while some other information may be selected by the user, or automatically selected by the WMS, from a presented drop-down pick-list or a third party data source. In some embodiments, the user may first enter or select a manufacturer's name and then select a particular product model from the selected manufacturer. In some embodiments, the WMS may automatically identify and download the warranty agreement from the manufacturer, while in other embodiments, the user may upload a copy of the warranty agreement.

Those skilled in the art will appreciate that many other warranty related information may be entered by the user or downloaded automatically by the WMS from the manufacturer or other third party data providers, without departing from the spirit of the present disclosure. For example, a product such as a car may require regular maintenance to maintain the warranty in force. In such case, the WMS may download a regular maintenance schedule and alert the user when the time for the next service appointment approaches.

In various embodiments, the user may also enter warranty information for services he has received. The warranty information for services may include some common and some different information than those entered for product warranties. For example, a service does not have a serial number or model number. However, a service performed may include other information not applicable to products, such as service agreement and description, date of performance, service package identifier, service provider identification, conditions for keeping the warranty in force, date for next maintenance call, and the like.

In various embodiments, the WMS may be coupled to manufacturers and/or service provider servers to download or upload various warranty related information. The manufacturers and service providers may benefit from their relationships with the WMS operator due to increased customer satisfaction and thus return business. The product and/or service providers may also further benefit from getting the warranty information for their products from the WMS, rather than directly from the customers, as many customers do not return the warranty card often provided in the product package or when service is provided. The customer also benefits by having to only return warranty information once to WMS, rather than providing it multiple times to both the WMS and the manufacturers, risking inconsistency in the information provided, such as date of purchase or place of purchase.

Third party service providers may offer extended or improved warranties for certain products or services. In various embodiments, the WMS may obtain and present such third party offers to the customer, further enhancing its services to the customer. Similarly, the WMS may also obtain such offers directly from manufacturers and service providers to present to the customers.

In various embodiments, the WMS may provide other warranty management services than keeping records. The WMS may provide one or more alerts to the user, via email, text, SMS, or other communication facilities, for warranties which are approaching their expiration dates. In addition to such alerts, the WMS may timely provide offers to purchase extended warranties or renewals to the customer after sending the alert about expiration of existing warranties. Since more than one warranty agreement is managed by the WMS, the user may use the WMS as a one-stop extended warranty shopping venue. This service greatly simplifies and reduces the user's expenditure of time and efforts when obtaining multiple extended warranties. Instead of the user having to find, research, and purchase a separate extended warranty agreement from each manufacturer or service provider separately, he can perform all required activities from the same familiar and integrated interface. This greatly reduces record keeping and communication overhead before, during, and after the purchase of the warranty agreements.

In various embodiments, the WMS may provide warranty offers for products and services for which the manufacturer or service provider, respectively, do not offer extended warranties or any warranties at all. In such cases, if the user wants to protect a purchased product or service, he will have a ready and easy source within WMS to obtain the appropriate warranty.

In some embodiments, the WMS may pool several warranties for sale to the customer at a reduced price, while negotiating to reduce the price with the warranty providers. The warranty providers may also benefit because of increased sale due to the convenience offered to the customer and decreased barriers to purchase extended warranty agreements.

FIG. 4 shows an example webpage for account creation and other warranty registration activities related to the webpage of FIG. 3. In various embodiments, webpage 400 includes content window 402, account creation section 404, login Username 406, login Password 408, extended warranty purchase prompt 410, user response buttons 412 for extended warranty offer, alert setup button 414, other product registration prompt 416, and user response button 418 for other product registration.

In various embodiments, an account may be created by the user with the owner and/or operator of the WMS for access to his warranty information. Those skilled in the art will appreciate that there are many ways of creating accounts based on name and password pairs or other credentials such as combinations of name, birth date, Social Security number, biological characteristics like fingerprints, touch-screen based pattern drawing, and the like. Once an account is created the user may login to his account online over the Internet from any computer, in web based embodiments, or from a computer having client side application software providing a WMS interface.

After the completion of the process of account creation, the user may be presented with various action options such as entering the warranty information for his various products and services, accepting extended warranty for each product or service entered, setting up alerts for warranty expirations or other events, considering purchasing third party warranties for products or services which have no original warranty from their manufacturers or service providers, and the like.

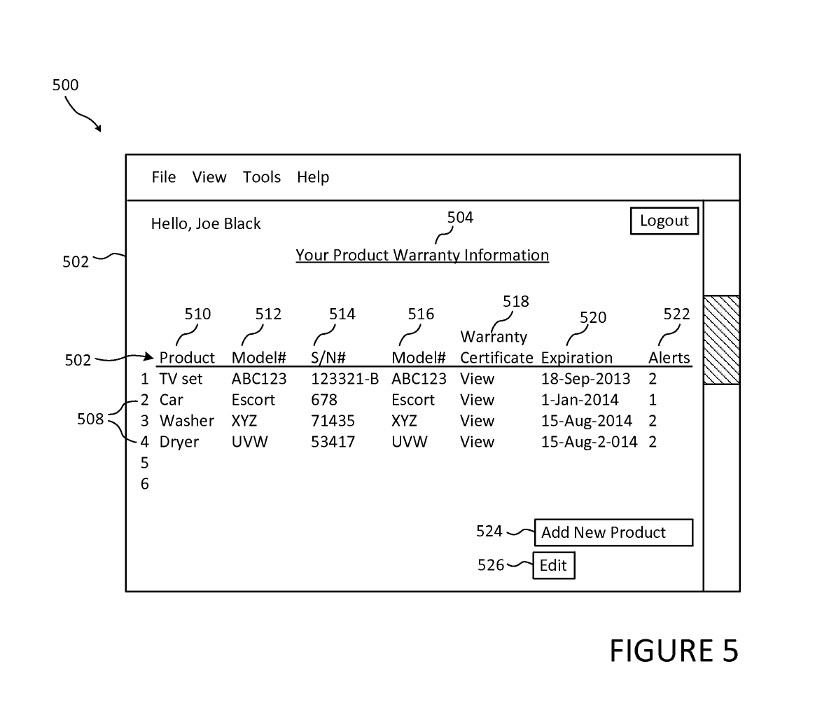

FIG. 5 shows an example webpage for showing a list of customer warranties configured to allow adding new product warranties and editing existing warranty records. In various embodiments, on user login, the WMS may present a user interface 500 including records of the various warranties belonging to the user. In some embodiments, the user interface includes a content window 502 showing a warranty table, a warranty table title 504, table headings 506 including data rows 508 and data columns for Product name 510, product model 512, product serial number 514, manufacturer identification 516, Warranty Certificate 518, Expiration date 520, and Alerts set 522. The user interface 500 may further include an Add New Product button 524 to add new warranty records, and Edit button 526 to edit existing warranty data.

In various embodiments, various editing tools and facilities are provided. The editing facilities may include functions for adding or deleting a whole row of data to create a new warranty record; editing an existing record; and selecting, adding, removing, or rearranging data columns. The columns generally represent categories of information directly or indirectly related to the warranty information. Other information functions offered may include hotlinks for accessing more information about the subject of the hotlink or open the corresponding record for editing, updating, and annotating the information. For example, selecting the hotlink corresponding to the Product column 510 may cause data about the selected product be presented to the user. The source of such data may be the manufacturer, a third party, or WMS. Selecting the hotlink may also provide the opportunity to edit the product identification, add description, annotations, and other information related to the product.

In some embodiments, the warranty data may be presented in forms other than tabular form. For example, warranty data may be displayed as a document with multiple sections, one for each warranty.

In some embodiments, the warranty database may be searched, filtered, limited, or expanded using various criteria, such as start or end date of warranty, type of warranty (product versus service), type of product, manufacturer, and the like.

In various embodiments, selecting a hotlink, for example, using touchscreen or mouse, corresponding to the entries under the Model number 512 or Serial Number 514 columns may cause more information to be displayed or allow the entries to be edited or annotated.

Selecting a manufacturer's name hotlink in the manufacturer column 516 may open a new webpage with information about the manufacturer or open the manufacturer's own home, warranty, or product webpage.

Selecting a hotlink or View corresponding to the warranty certificate or agreement in Warranty Certificate column 518 may cause the certificate document to be presented for viewing in its entirety and/or annotating it.

Selecting an Expiration date 520 entry hotlink may cause the expiration information to be displayed in addition to offering extended warranty for the product after the expiration.

Selecting an entry hotlink under the Alert 522 column may cause information about the alerts to be displayed and further provide the opportunity to set new alerts, for example, at different time intervals or different lengths of time prior to the expiration, such as 3 months before, 1 month before and 1 week before.

In various embodiments, the WMS may aggregate warranty information based on various criteria, such as common manufacturers, common product or service type, cost, and the like, to obtain industry level statistics about warranties such as price trends, features, customer preferences, and the like. Such statistics may then be used for marketing warranties and extended warranties to customers based on best fit. Manufacturers and service providers ma also use such information to improve their warranty offerings and pricing.

In various embodiments, the WMS may provide other services such as processing or facilitating customer claims against an existing warranty. Such processing may include obtaining claim information and communicating it to the manufacturers or service providers, providing replacement or repair information to the customer, and coordinating the remedial actions, among others.

Those skilled in the art will appreciate that the warranty table may include service warranty data records in addition to the product entries. In some embodiments, selecting a service entry automatically causes the table columns to change to parameters which are relevant to the service entry such as display of service description instead of product name and removal of model and serial number columns. In other embodiments, the product warranty and service warranty tables may be presented separately, each with its own relevant columns.

Those skilled in the art will further appreciate that more, fewer, or different columns may be displayed in warranty tables without departing from the spirit of the present disclosures. For example, an extended warranty cost column may be displayed in addition to others.

It will be further understood that unless explicitly stated or specified, the steps described in a process are not ordered and may not necessarily be performed or occur in the order described or depicted. For example, a step A in a process described prior to a step B in the same process, may actually be performed after step B. In other words, a collection of steps in a process for achieving an end-result may occur in any order unless otherwise stated.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

What is claimed is:

1. A Warranty Management System (WMS) comprising:
a software module that when executed on a computing device causes the computing device to:
present an integrated user interface configured to allow a user to enter multiple product and service warranty information; and
wherein the integrated user interface is further configured to allow the user to manage the multiple product and service warranty information.

2. The WMS of claim 1, wherein the software module comprises one of a webpage and a client-side software application.

3. The WMS of claim 1, wherein the WMS is configured to send an alert to the user indicating an approach of an expiration date of a warranty for a product or a service.

4. The WMS of claim 1, wherein the product warranty information includes at least one of product identification, product model number, product serial number, product manufacturer, and warranty certificate.

5. The WMS of claim 1, wherein the service warranty information includes at least one of service identification, service provider identification, and warranty certificate.

6. The WMS of claim 1, wherein the WMS comprises client side and server side software modules.

7. The WMS of claim 1, wherein the WMS comprises a database for storing warranty information supplied by multiple customers.

8. The WMS of claim 1, wherein the WMS is configured to allow the user to edit the user's warranty records.

9. The WMS of claim 1, wherein the WMS is configured to offer an extended warranty to the user for multiple products and services.

10. A method of warranty management, the method comprising:
using a Warranty Management System (WMS) having an integrated user interface configured to allow a user to enter multiple product and service warranty information;
entering multiple product and service warranty information using the integrated user interface; and
changing the entered multiple product and service warranty information using the integrated user interface.

11. The method of claim 10, further comprising searching for one of the multiple product and service warranty information using the integrated user interface.

12. The method of claim 10, wherein the WMS comprises a webpage.

13. The method of claim 10, wherein the integrated user interface is configured to allow the user to select one or more categories of information of the multiple product and service warranty information to be displayed.

14. The method of claim 10, wherein at least some of the multiple product and service warranty information are displayed by the WMS as hotlinks.

15. The method of claim 10, wherein the at least some of the multiple product and service warranty information are obtained by the WMS from sources other than the user.

16. A method of obtaining warranty for products and services, the method comprising:
using a Warranty Management System (WMS) having an integrated user interface configured to allow a user to enter multiple product and service identification information;
receiving warranty offers for the entered multiple products and services; and
purchasing warranty certificates for one or more of the entered multiple products and services.

17. The method of claim 16, further comprising receiving extended warranty offers after receiving alerts that an existing warranty is nearing expiration.

18. The method of claim 16, further comprising obtaining at least some of the multiple product and service warranty information from sources other than the user.

19. The method of claim 16, wherein the WMS comprises a webpage.

20. The method of claim 16, wherein the source of the received warranty is a third party provider.
